(19) United States
(12) Patent Application Publication
(10) Pub. No.: US 2025/0293918 A1
(43) Pub. Date: Sep. 18, 2025

(54) Optimized Traffic Switchover Across Redundant Switch Cards

(71) Applicant: Arista Networks, Inc., Santa Clara, CA (US)

(72) Inventors: Jeff Jing Yuen CHAN, Burnaby (CA); Karankumar JAGJITKUMAR, Maple Ridge (CA)

(21) Appl. No.: 18/606,422

(22) Filed: Mar. 15, 2024

(51) Int. Cl. H04L 41/0668; H04L 45/745

(52) U.S. Cl. CPC H04L 41/0668; H04L 45/74591

(57) ABSTRACT

Techniques for implementing optimized traffic switchover across the redundant (primary and secondary) switch cards of a network device are provided. In certain embodiments these techniques involve programming, for each front panel port of each the device's line cards, a first TCAM rule that includes a first match criterion matching network packets received on the front panel port, a second match criterion matching network packets received while a global object is set to a first value associated with the primary switch card, and a first action that causes matched network packets to be redirected to the primary switch card; and a second TCAM rule that includes the first match criterion, a third match criterion matching network packets received while the global object is set to a second value associated with the secondary switch card, and a second action that causes matched network packets to be redirected to the secondary switch card.

### BACKGROUND

In network devices that implement a centralized switch architecture (referred to herein as CSA network devices), most or all data plane packet processing is centrally handled by a pair of redundant switch cards. Each switch card is coupled via an internal fabric to a set of line cards. Each line card is in turn associated with a subset of front panel ports and passes network traffic between those front panel ports and the currently active switch card.

### BRIEF DESCRIPTION OF THE DRAWINGS

With respect to the discussion to follow and in particular to the drawings, it is stressed that the particulars shown represent examples for purposes of illustrative discussion and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 depicts an example CSA network device in accordance with certain embodiments of the present disclosure.

FIG. 2 depicts a high-level workflow in accordance with certain embodiments of the present disclosure.

FIG. 3 depicts a line card configuration workflow in accordance with certain embodiments of the present disclosure.

FIG. 4 depicts a packet processing workflow in accordance with certain embodiments of the present disclosure.

FIG. 5 depicts an optimized traffic switchover workflow in accordance with certain embodiments of the present disclosure.

### DETAILED DESCRIPTION

In the following description, for purposes of explanation, numerous examples and details are set forth in order to provide an understanding of embodiments of the present disclosure. Particular embodiments as expressed in the claims may include some or all of the features in these examples, alone or in combination with other features described below, and may further include modifications and equivalents of the features and concepts described herein.

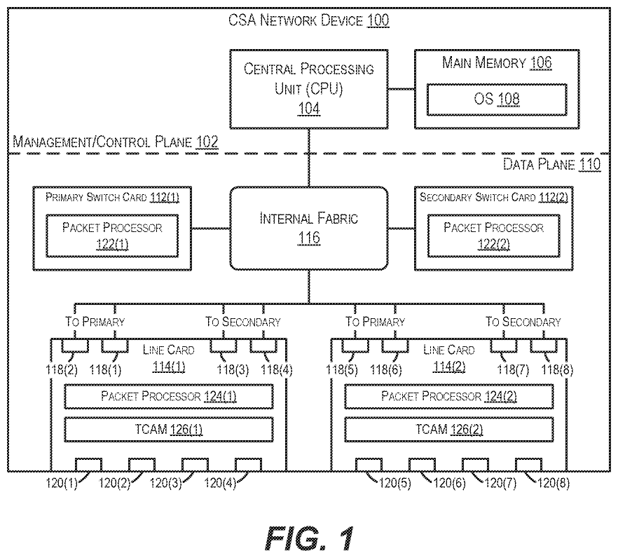

Embodiments of the present disclosure are directed to techniques for switching over network traffic across the redundant switch cards of a CSA network device in an optimized manner. FIG. 1 is a simplified block diagram of an example CSA network device 100 in which these techniques can be implemented. CSA network device 100 may be a network switch, a network router, or any other type of device operable for transmitting and/or processing network packets in a computer network. In certain embodiments, CSA network device 100 may be a chassis-based network device, which means that it consists of a chassis (frame) into which various modular components and/or cards can be inserted and removed in order to meet the specific needs of the entity that has deployed the device.

CSA network device 100 includes a management/control plane 102 comprising a central processing unit (CPU) 104 and a main memory (e.g., random-access memory or RAM) 106. CPU 104 is generally responsible for managing the configuration of CSA network device 100 and controlling the device's understanding of the network in which it resides. CPU 104 carries out these functions under the direction of an OS 108 that runs on the CPU from main memory 106. Although not shown, in the case where CSA network device 100 is a chassis-based device, CPU 104 and main memory 106 may reside on a modular supervisor card that can be inserted into and removed from the chassis of the device.

CSA network device 100 further includes a data plane 110 comprising a pair of redundant switch cards 112 (i.e., a primary switch card 112(1) and a secondary switch card 112(2)) and a set of line cards 114. In FIG. 1, two line cards 114(1) and 114(2) are depicted for illustration purposes; however, CSA network device 100 may include any number of line cards. Like the supervisor card noted above, in the case where CSA network device 100 is a chassis-based device, switch cards 112 and line cards 114 can be modular cards that are capable of being inserted into and removed from the chassis of the device. Each line card 114 is coupled with switch cards 112 (and with CPU 104) via an internal fabric 116. For example, line card 114(1) comprises two internal fabric ports 118(1) and 118(2) connected via internal fabric 116 to primary switch card 112(1) and two internal fabric ports 118(3) and 118(4) connected via internal fabric 116 to secondary switch card 112(2). Similarly, line card 114(2) comprises two internal fabric ports 118(5) and 118(6) connected via internal fabric 116 to primary switch card 112(1) and two internal fabric ports 118(7) and 118(8) connected via internal fabric 116 to secondary switch card 112(2). Each line card 114 is also coupled with (or includes) one or more front panel ports 120 of CSA network device 100. For example, line card 114(1) includes four front panel ports 120(1)-(4) and line card 120(2) includes another four front panel ports 120(5)-(8). As with the number of line cards, the specific number of internal fabric ports and front panel ports depicted in FIG. 1 for each line card 114 is illustrative and not intended to be limiting.

Switch cards 112 are generally responsible for processing, in hardware, network packets that pass through CSA network device 100 (i.e., enter and exit the device via front panel ports 120) based on configuration information determined by OS 108 running on CPU 104. The types of packet processing that can be performed by switch cards 112 include Layer 2 (L2) forwarding, Layer 3 (L3) routing, and so on. Each switch card 112 executes this processing via a packet processor 122, which is typically an application-specific integrated circuit (ASIC) or a field-programmable gate array (FPGA). Because switch cards 112 are redundant, only a single switch card is active at a given time. For example, during normal operation, primary switch card 112(1) is active and processes network traffic while secondary switch card 112(2) operates in a standby state. If primary switch card 112(1) experiences a failure, secondary switch card 112(2) becomes active and takes over packet processing duties from the primary switch card. Once primary switch card 112(1) recovers from its failure, it can once again become active and secondary switch card 112(1) can return to its standby state. Alternatively, secondary switch card 112(1) can remain active in this scenario until it experiences a failure (at which point primary switch card 112(1) will become active).

Line cards 114 are generally responsible for forwarding network packets between their respective front panel ports 120 and the currently active switch card, thereby enabling the active switch card to carry out its packet processing duties on ingress and egress network traffic. Each line card 114 performs this forwarding via a packet processor 124 that is different from (and generally less complex in design than) the switch card packet processors. For example, a typical packet flow through CSA network device 100 proceeds as follows:
1. A network packet enters CSA network device 100 on a front panel port P1.
2. A line card L1 associated with (e.g., coupled with or comprising) front panel port P1receives the network packet and L1's packet processor redirects the packet to an internal fabric port F1 of L1 that is mapped to P1 and leads to the currently active switch card.
3. The active switch card receives the packet from line card L1, processes the packet using its packet processor, and forwards the packet via the internal fabric to another (egress) line card L2.
4. Line card L2 receives the processed packet from the active switch card on an internal fabric port F2 and L2's packet processor redirects the packet to a front panel port P2 of L2 that is mapped to F2, thereby transmitting the packet out of the device towards its destination.

The packet redirection performed by the packet processors of line cards L1 and L2 at steps (2) and (4) above is typically achieved via ternary content-addressable memory (TCAM) rules that are programmed into a TCAM of each line card. This TCAM (which is a type of high-speed memory that enables fast, parallel search of its contents) is coupled with, or a part of, the line card packet processor and is shown via reference numeral 126 in FIG. 1.

For example, according to one traditional approach, OS 108 of CSA network device 100 programs TCAM 126 of each line card 114 with two TCAM rules for each front panel port 120 of the line card in order to implement the redirection at step (2) (i.e., redirection of ingress packets to the currently active switch card): a first TCAM rule R1 that matches packets received on the front panel port and redirects the matched packets to an internal fabric port 118 connected to primary switch card 112(1), and a second TCAM rule R2 that matches packets received on the front panel port and redirects the matched packets to an internal fabric port 118 connected to the secondary switch card 112(2). In addition, to prevent duplication of packets, OS 108 disables second TCAM rule R2 by default and enables first TCAM rule R1 by default. This causes all ingress network traffic to be redirected to primary switch card 112(1), which will normally be the active switch card. When a failure occurs at primary switch card 112(1), OS 108 initiates a traffic switchover process that involves disabling first TCAM rule R1 and enabling second TCAM rule R2 for every front panel port 120. Once the traffic switchover is complete, all ingress network traffic will be redirected to secondary (now currently active) switch card 112(2).

One issue with this traditional approach is that enabling/disabling TCAM rules R1 and R2 to implement traffic switchover is relatively slow. Enabling and disabling TCAM rules are expensive operations because they usually involve programming multiple hardware tables, and these operations must be performed for every front panel port 120 of CSA network device 100 (which can potentially number in the hundreds). Further, while the traffic switchover is in progress CSA network device 100 cannot process any network traffic, which means that it is desirable to minimize the time needed to complete the switchover to the extent possible.

To address the foregoing, embodiments of the present disclosure provide a framework for optimizing the traffic switchover process. Like the traditional approach above, in certain embodiments this framework involves programming TCAM 126 of each line card 114 of CSA network device 100 with at least two TCAM rules per front panel port 120 in order to redirect ingress network traffic to the currently active switch card: a first TCAM rule R1′ designed to redirect ingress packets received on that front panel port to a corresponding internal fabric port 118 connected to primary switch card 112(1), and a second TCAM rule R2′ designed to redirect ingress packets received on that front panel port to a corresponding internal fabric port 118 connected to secondary switch card 112(2).

However, in various embodiments, TCAM rules R1′ and R2′ are always enabled (rather than having one enabled and the other disabled), and each of these rules includes an additional match criterion that matches ingress packets based on the value of a global object. Specifically, first TCAM rule R1′ (which redirects packets to primary switch card 112(1)) includes an additional match criterion that matches ingress packets when the global object is set to a first value associated with primary switch card 112(1), and second TCAM rule R2′ (which redirects packets to secondary switch card 112(2)) includes an additional match criterion that matches ingress packets when the global object is set to a second value associated with secondary switch card 112(2).

With TCAM rules R1′ and R2′ in place for every front panel port 120 of CSA network device 100, the global object is set to the first value associated with primary switch card 112(1) during normal operation (i.e., when the primary switch card is active). This causes all ingress network traffic to match first TCAM rule R1′ and be redirected to the primary (currently actively) switch card. Upon occurrence/detection of a failure at primary switch card 112(1), the global object is changed from the first value to the second value. This causes all ingress network traffic received from that point onward to be redirected to secondary (now currently active) switch card 112(2). Because this framework streamlines the traffic switchover process to simply changing the value of the single global object, the framework can achieve a significantly faster switchover time than the traditional approach that involves enabling/disabling per-port TCAM rules (e.g., sub 100 milliseconds in contrast to approximately 800-900 milliseconds), resulting in a shorter outage window and an improved experience for users/customers of CSA network device 100.

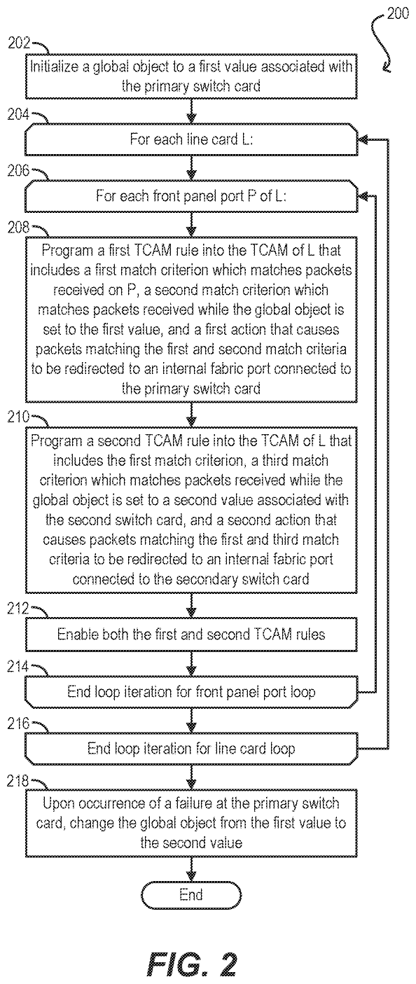

FIG. 2 depicts a high-level workflow 200 that can be performed by CSA network device 100 of FIG. 1 for implementing the foregoing framework according to certain embodiments. Starting with step 202, CSA network device 100 can initialize a global object to a first value that is associated with primary switch card 112(1). CSA network device 100 can then enter a first loop for each line card L of the device (step 204) and a second loop for each front panel port P associated with line card L (step 206).

Within the second loop, CSA network device 100 can program a first TCAM rule into the TCAM of line card L (i.e., rule R1′ mentioned above) that includes a first match criterion which matches network packets received on front panel port P, a second match criterion which matches network packets received while the global object is set to the first value associated with primary switch card 112(1), and a first action that causes network packets which match the first match criterion and the second match criterion to be redirected to an internal fabric port of L connected to primary switch card 112(1) (step 208). This internal fabric port may be a port that is specifically mapped to front panel port P by the line card's packet processor.

Further, at step 210, CSA network device 100 can program a second TCAM rule into the TCAM of line card L (i.e., rule R2′ mentioned above) that includes the first match criterion noted above, a third match criterion which matches network packets received while the global object is set to a second value associated with secondary switch card 112(2), and a second action that causes network packets which match the first match criterion and the third match criterion to be redirected to an internal fabric port of L connected to secondary switch card 112(2).

Upon programming the first and second TCAM rules, CSA network device 100 can enable both rules (step 212), reach the end of the current iteration of the second loop (step 214), and return to step 206 in order to process the next front panel port P associated with line card L. Upon processing all of line card L's front panel ports, CSA network device 100 can reach the end of the current iteration of the first loop (step 216) and return to step 204 in order to process the next line card.

Upon iterating through all of its line cards, CSA network device 100 can operate normally (not shown). During this time, all network traffic received on front panel ports 120 will match the first TCAM rule programmed at step 208 and be redirected to primary switch card 112(1) because the global object is set to the first value per step 202.

Finally, when a failure occurs at primary switch card 112(1), CSA network device 100 can change the global object from the first value to the second value (step 218). This will cause all network traffic received on front panel ports 120 from that point onward to match the second TCAM rule programmed at step 210 and be redirected to secondary switch card 112(2), which is now the currently active switch card.

In one set of embodiments, the global object can be a variable that is managed in software by, e.g., OS 108 running on CPU 104 of CSA network device 100. In these embodiments, OS 108 can detect when a failure at primary switch card 112(1) occurs and can change the value of the variable accordingly. For example, the variable can be a virtual local area network (VLAN) class identifier (ID) that is maintained in a VLAN table of each line card 114 and is associated with a common VLAN ID that is assigned to every front panel port 120 (e.g., VLAN 1). Because line cards typically do not perform packet processing functions in CSA network devices like device 100 of FIG. 1 (these functions are handled centrally by the switch cards), all of the front panel ports of every line card 114 can be programmed to be part of the same VLAN internally for this purpose. As another example, the variable can be a source virtual path (SOURCE_VP) class ID that is maintained in a SOURCE_VP table of each line card 114 and is associated with a common SOURCE_VP ID assigned to every front panel port 120 (e.g., SOURCE_VP 1). Like the VLAN example, because line cards 114 do not perform packet processing functions, all of the front panel ports of every line card 114 can be mapped to the same SOURCE_VP internally for this purpose.

In another set of embodiments, the global object can comprise one or more hardware signals that are generated by one or more components of CSA network device 100. For example, some chassis-based CSA network devices are configured to generate and send a hardware signal from each switch card to the device's line cards indicating whether the switch card is physically installed (i.e., inserted) in the device's chassis or not (e.g., 1 if installed, 0 if not). If CSA network device 100 is such a device, the following three TCAM rules can be programmed into TCAM 126 of every line card 114 for each of the line card's front panel ports (i.e., port P):
a first TCAM rule that includes a first match criterion which matches network packets received on front panel port P, a second match criterion which matches network packets received while a concatenation of hardware signals sent by the primary and secondary switch cards indicates that the primary is installed and the secondary is not (e.g., “10”), and a first action that causes network packets which match the first match criterion and the second match criterion to be redirected to the primary switch card;
a second TCAM rule that includes the first match criterion, a third match criterion which matches network packets received while a concatenation of hardware signals sent by the primary and secondary switch cards indicates that the secondary is installed and the primary is not (e.g., “01”), and a second action that causes network packets which match the first match criterion and the third match criterion to be redirected to the secondary switch card; and
a third TCAM rule that includes the first match criterion, a fourth match criterion which matches network packets received while a concatenation of hardware signals sent by the primary and secondary switch cards indicates that both the primary and secondary are installed (e.g., “11”), and a third action that causes network packets which match the first match criterion and the fourth match criterion to be redirected to a predetermined one of the two switch cards.

This hardware signal-based approach can achieve an even faster traffic switchover time than the approach that uses a software-managed variable for the global object, but only applies to failure scenarios where the active switch card is physically removed from CSA network device 100. Accordingly, the software-managed variable approach is preferable in scenarios where the active switch card can experience some other type of failure (e.g., parity failure, etc.).

The remaining sections of this disclosure describe an implementation of the framework with respect to CSA network device 100 in embodiments where the global object is a software-managed VLAN class ID that is maintained in the VLAN tables of line cards 114. It should be appreciated that FIGS. 1 and 2 and the foregoing high-level description are illustrative and not intended to be limiting. For example, although FIG. 1 depicts a particular arrangement of components within CSA network device 100, other arrangements are possible (e.g., the functionality attributed to a particular component may be split into multiple components, components may be combined, etc.). Further, although FIG. 2 indicates that CSA network device 100 iterates through its line cards (and the front panel ports associated with each line card) in a sequential manner in order to program TCAM rules into the line cards' TCAMs, in alternative embodiments some or all of these TCAM programming steps may be performed in parallel.

### 1. Line Card Configuration Workflow

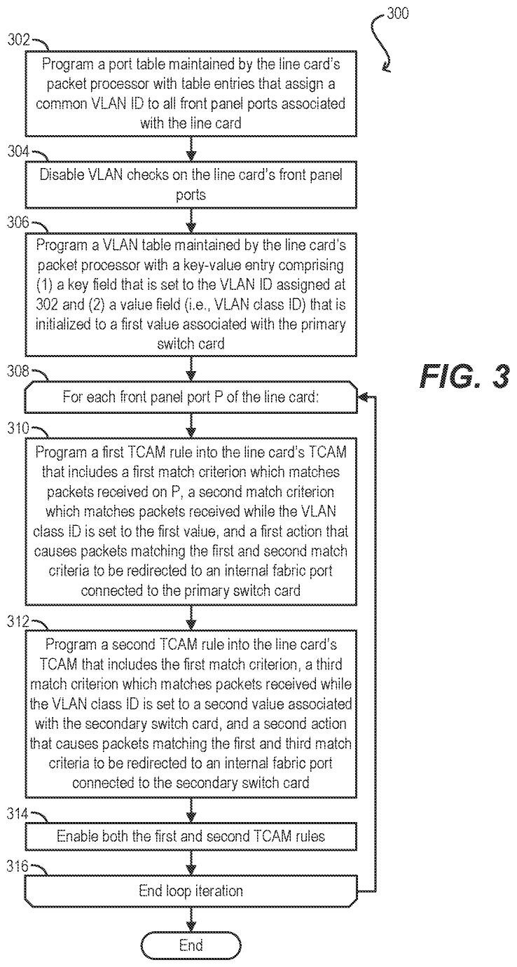

FIG. 3 depicts a workflow 300 that may be performed by OS 108 of CSA network device 100 for configuring the device's line cards 114 to support optimized traffic switchover based on VLAN class ID according to certain embodiments. In particular, workflow 300 presents the configuration steps performed by OS 108 with respect to a single line card, under the assumption that the same steps will be repeated for every line card of CSA network device 100. OS 108 may initiate workflow 300 when this optimized traffic switchover functionality is enabled on the device or at the time of device boot up/initialization.

Starting with step 302, OS 108 can program a port table maintained by the line card's packet processor 124 with table entries that assign a common VLAN ID (e.g., VLAN 1) to all front panel ports 120 associated with the line card.

At step 304, OS 108 can disable VLAN checks on the line card's front panel ports, because the assigned VLAN ID will not be used for L2 forwarding.

At step 306, OS 108 can program a VLAN table maintained by the line card's packet processor 124 with a key-value entry comprising (1) a key field that is set to the VLAN ID assigned to the line card's front panel ports at step 302, and (2) a value field (which corresponds to the VLAN class ID for the VLAN specified in the key field) that is initialized to a first value associated with primary switch card 112(1).

At step 308, OS 108 can enter a loop for each front panel port P of the line card. Within this loop, OS 108 can program a first TCAM rule into the line card's TCAM 126 with a first match criterion that matches network packets received on front panel port P, a second match criterion that matches network packets received while the value field of the key-value entry programmed into the line card's VLAN table (i.e., the VLAN class ID) is set to the first value, and a first action that causes network packets which match the first match criterion and the second match criterion to be redirected to an internal fabric port that leads to primary switch card 112(1) (step 310).

Further, at step 312, OS 108 can program a second TCAM rule into the line card's TCAM 126 with the first match criterion, a third match criterion that matches network packets received while the value field of the key-value entry programmed into the line card's VLAN table (i.e., the VLAN class ID) is set to a second value associated with secondary switch card 112(2), and a second action that causes network packets which match the first match criterion and the third match criterion to be redirected to an internal fabric port that leads to secondary switch card 112(2).

By way of example, the following table presents sample TCAM rules that may be programmed at steps 310 and 312 for a front panel port called “Ethernet1”:

TABLE 1

| | Match | |
|---|---|---|
| Match criterion 1: | criterion 2: | |
| Ingress port ID | VLAN class ID | Action |
| Ethernet1 | 0 (associated | Redirect to internal fabric |
| | with primary | port Fabric1 (which is |
| | switch card) | mapped to Ethernet1 and |
| | | leads to primary switch card) |
| Ethernet1 | 1 (associated | Redirect to internal fabric |
| | with secondary | port Fabric2 (which is |
| | switch card) | mapped to Ethernet1 and |
| | | leads to secondary switch |
| | | card) |

Upon programming the first and second TCAM rules, OS 108 can enable both of the rules (step 314) and reach the end of the current loop iteration (step 316). OS 108 can then return to step 308 in order to program TCAM rules for the next front panel port P of the line card.

Finally, once all the line card's front panel ports are processed per steps 308-316, the line card configuration is complete and workflow 300 can end.

### 2. Packet Processing Workflow

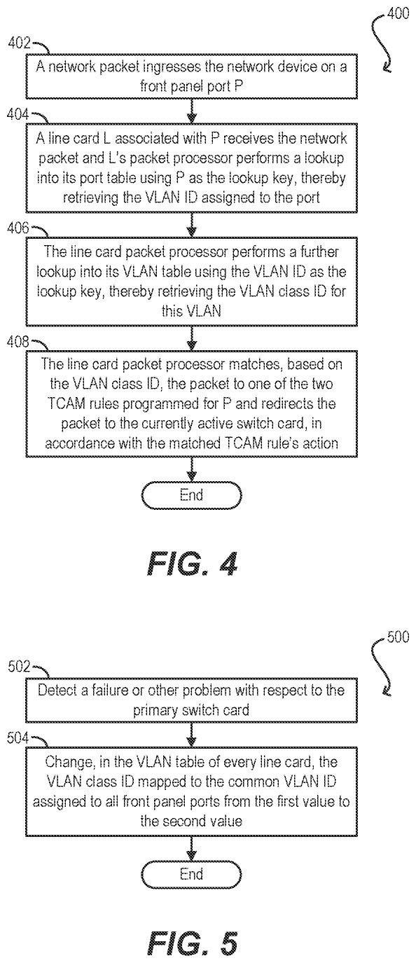

FIG. 4 depicts a workflow 400 that may be performed by CSA network device 100 for processing an ingress network packet according to certain embodiments. Workflow 400 assumes that the device's line cards 114 have been configured per workflow 300 of FIG. 3.

Starting with step 402, a network packet can ingress CSA network device 100 on a front panel port P.

In response, a line card L associated with front panel port P can receive the network packet and L's packet processor 124 can perform a lookup into the line card's port table using the ID of front panel port P as a key, thereby retrieving the common VLAN ID assigned to the port (e.g., VLAN 1) (step 404). Note that if the network packet includes a VLAN tag specifying a VLAN ID, that VLAN tag will be ignored by line card L's packet processor 124, thereby ensuring that packet processor 124 retrieves the common VLAN ID programmed for front panel port P in the VLAN table. Packet processor 124 can then perform a further lookup into the line card's VLAN table using the retrieved VLAN ID as a key, thereby retrieving the VLAN class ID associated with that VLAN ID (step 406). As mentioned previously, this VLAN class ID will be initialized with a first value that is associated with primary switch card 112(1).

Finally, packet processor 124 can match, based on the VLAN class ID retrieved at step 406, the network packet to one of the two TCAM rules programmed for front panel port P at steps 310 and 312 of workflow 300 and can redirect the packet to the currently active switch card in accordance with the matched TCAM rule's action (step 408). For example, if CSA network device 100 is operating normally (i.e., without any switch card failures), packet processor 124 will match the first TCAM rule programmed at step 310 and redirect the network packet to primary switch card 112(1).

### 3. Optimized Traffic Switchover Workflow

FIG. 5 depicts a workflow 500 that may be performed by OS 108 of CSA network device 100 for carrying out an optimized traffic failover from primary switch card 112(1) to secondary switch card 112 (1) based on VLAN class ID according to certain embodiments. Like packet processing workflow 400, workflow 500 assumes that the device's line cards 114 have been configured per workflow 300 of FIG. 3.

At step 502, OS 108 can detect a failure or other problem with respect to primary switch card 112(1) that necessitates a switchover of traffic from the primary switch card to secondary switch card 112(2). For example, this failure/problem may be a parity failure, a failure caused by a loose or disengaged connection between the primary switch card and the device chassis, etc.

Upon detecting the failure/problem, OS 108 can change, in the VLAN table of every line card 114, the VLAN class ID mapped to the common VLAN ID assigned to all front panel ports 120 from the first value associated with primary switch card 112(1) to the second value associated with secondary switch card 112(2) (step 504). This will cause the line cards' packet processors to redirect future ingress network traffic to the secondary (now currently active) switch card.

The above description illustrates various embodiments of the present disclosure along with examples of how aspects of these embodiments may be implemented. The above examples and embodiments should not be deemed to be the only embodiments and are presented to illustrate the flexibility and advantages of the present disclosure as defined by the following claims. For example, although certain embodiments have been described with respect to particular workflows and steps, it should be apparent to those skilled in the art that the scope of the present disclosure is not strictly limited to the described workflows and steps. Steps described as sequential may be executed in parallel, order of steps may be varied, and steps may be modified, combined, added, or omitted. As another example, although certain embodiments may have been described using a particular combination of hardware and software, it should be recognized that other combinations of hardware and software are possible, and that specific operations described as being implemented in hardware can also be implemented in software and vice versa.

The specification and drawings are, accordingly, to be regarded in an illustrative rather than restrictive sense. Other arrangements, embodiments, implementations, and equivalents will be evident to those skilled in the art and may be employed without departing from the spirit and scope of the present disclosure as set forth in the following claims.

1. A method performed by a network device comprising a primary switch card, a secondary switch card, and one or more line cards that are communicatively coupled with the primary and secondary switch cards, the method comprising:
initializing a global object to a first value associated with the primary switch card;
for each line card:
for each front panel port of the network device that is associated with the line card:
programming a first ternary content-addressable memory (TCAM) rule into a TCAM of the line card that includes a first match criterion matching network packets received on the front panel port, a second match criterion matching network packets which are received while the global object is set to the first value, and a first action that causes network packets which match the first match criterion and the second match criterion to be redirected to the primary switch card;
programming a second TCAM rule into the TCAM of the line card that includes the first match criterion, a third match criterion matching network packets which are received while the global object is set to a second value associated with the secondary switch card, and a second action that causes network packets which match the first match criterion and the third match criterion to be redirected to the secondary switch card; and
enabling the first and second TCAM rules; and
upon occurrence of a failure at the primary switch card, causing the global object to change from the first value to the second value.

2. The method of claim 1 wherein the global object is a variable that is managed by an operating system (OS) running on a central processing unit (CPU) of the network device.

3. The method of claim 2 wherein the OS changes the global object from the first value to the second value in response to detecting the failure at the primary switch card.

4. The method of claim 2 wherein the variable is a virtual local area network (VLAN) class identifier (ID) that is maintained in a VLAN table of each line card and is associated with a common VLAN ID that is assigned to every front panel port of the network device.

5. The method of claim 2 wherein the variable is a source virtual path (SOURCE_VP) class ID that is maintained in a SOURCE_VP table of each line card and is associated with a common SOURCE_VP ID that is assigned to every front panel port of the network device.

6. The method of claim 4 further comprising, for each line card:
programming entries into a port table of the line card that assigns the common VLAN ID to every front panel port associated with the line card.

7. The method of claim 6 further comprising, for each line card:
programming a key-value entry into the VLAN table with a key field set to the common VLAN ID and a value field set to the first value, the value field corresponding to the VLAN class ID.

8. The method of claim 1 wherein the global object corresponds to one or more hardware signals generated by one or more components of the network device.

9. The method of claim 8 wherein the failure is a physical removal of the primary switch card from the network device.

10. The method of claim 8 wherein the first value is a concatenation of hardware signals indicating that the primary switch card is installed in the network device and the secondary switch card is not installed in the network device.

11. The method of claim 8 wherein the second value is a concatenation of hardware signals indicating that the secondary switch card is installed in the network device and the primary switch card is not installed in the network device.

12. The method of claim 8 further comprising, for said each front panel port:
programming a third TCAM rule into the TCAM of the line card that includes the first match criterion, a fourth match criterion matching network packets that are received while the global object is set to a concatenation of hardware signals indicating that the primary and secondary switch cards are both installed in the network device, and a third action that causes matched network packets to be redirected to a predetermined one of the primary and secondary switch cards.

13. A network device comprising:
a central processing unit (CPU);
a primary switch card;
a secondary switch card;
one or more line cards; and
a plurality of front panel ports,
wherein the network device is configured to:
initialize a global object to a first value associated with the primary switch card;
for each line card:
for each front panel port of the network device that is associated with the line card:
program a first ternary content-addressable memory (TCAM) rule into a TCAM of the line card that includes a first match criterion matching network packets received on the front panel port, a second match criterion matching network packets which are received while the global object is set to the first value, and a first action that causes network packets which match the first match criterion and the second match criterion to be redirected to the primary switch card;
program a second TCAM rule into the TCAM of the line card that includes the first match criterion, a third match criterion matching network packets which are received while the global object is set to a second value associated with the secondary switch card, and a second action that causes network packets which match the first match criterion and the third match criterion to be redirected to the secondary switch card; and
enable the first and second TCAM rules; and
upon detecting a failure at the primary switch card, change the global object from the first value to the second value.

14. The network device of claim 13 wherein the global object is a variable that is managed by an operating system (OS) running on the CPU.

15. The network device of claim 14 wherein the variable is a virtual local area network (VLAN) class identifier (ID) that is maintained in a VLAN table of each line card and is associated with a common VLAN ID that is assigned to every front panel port of the network device.

16. The network device of claim 14 wherein the variable is a source virtual path (SOURCE_VP) class ID that is maintained in a SOURCE_VP table of each line card and is associated with a common SOURCE_VP ID that is assigned to every front panel port of the network device.

17. The network device of claim 13 wherein the global object corresponds to one or more hardware signals generated by one or more components of the network device.

18. A method performed by a network device comprising a primary switch card, a secondary switch card, and one or more line cards that are communicatively coupled with the primary and secondary switch cards, the method comprising, for each line card:
programming, for each front panel port of the network device that is associated with the line card, a first ternary content-addressable memory (TCAM) rule into a TCAM of the line card that includes a first match criterion matching network packets received on the front panel port, a second match criterion matching network packets which are received while a global object is set to a first value associated with the primary switch card, and a first action that causes network packets which match the first match criterion and the second match criterion to be redirected to the primary switch card; and
programming, for said each front panel port, a second TCAM rule into the TCAM of the line card that includes the first match criterion, a third match criterion matching network packets which are received while the global object is set to a second value associated with the secondary switch card, and a second action that causes network packets which match the first match criterion and the third match criterion to be redirected to the secondary switch card.

19. The method of claim 18 wherein the first and second TCAM rules are enabled by default.

20. The method of claim 18 wherein the global object is initialized to the first value.
